(19) United States
(12) Patent Application Publication
(10) Pub. No.: US 2026/0313308 A1
(43) Pub. Date: Oct. 8, 2026

(54) PERFORMING COMMON AUDIO CONVOLUTIONS USING ISO-TRAJECTORIES IN THREE DIMENSIONAL (3D) SPACE

(71) Applicant: GOOGLE LLC, Mountain View, CA (US)

(72) Inventors: Dongeek Shin, San Jose, CA (US); Sinan Hersek, Seattle, WA (US)

(21) Appl. No.: 19/481,791

(22) PCT Filed: Jun. 8, 2023
(86) PCT No.: PCT/US2023/068146

§ 371 Date: Nov. 5, 2025

(51) Int. Cl. H04S 7/00; H04S 3/00

(52) U.S. Cl. CPC H04S 7/302; H04S 3/008; H04S 7/305; H04S 2400/01; H04S 2400/11; H04S 2420/01

(57) ABSTRACT

Techniques include using the fact that the HRTF depends on a sound source position on a unit sphere relative to a listener while the reverb transfer function depends on a range relative to the listener. In this way, sound source positions along a line in three-dimensional space have an identical HRTF while speaker positions along a circular arc in three-dimensional space have an identical reverb transfer function. Accordingly, identify those sound source positions along a line and use a common HRTF in a single convolution for each ear, and those speaker positions along an arc and use a common reverb transfer function in a single convolution for each ear.

### TECHNICAL FIELD

This description relates in general to audio devices used in virtual reality and augmented reality (VR/AR) devices.

### BACKGROUND

A sound field generated at an array of virtual sound sources can reproduce the effect of a sound source from any vantage point relative to a listener. Such a sound field may be decoded and used in the delivery of audio through headphone speakers in, e.g., Virtual Reality (VR) and/or augmented reality (AR) systems.

### SUMMARY

This application is directed to binaural rendering of audio signals in a three-dimensional space for a listener. Binaural rendering involves computing convolutions of audio signals with head-related transfer functions (HRTFs) for each ear of the listener. In addition, the room in which the listener hears the audio signals may have its own reverb transfer function that represents the effects of reflections off the walls, ceilings, floors, and other obstacles in the room on the audio signals. For a binaural rendering, there are four convolutions (two HRTFs and two reverbs, one for each ear) for each audio source. Accordingly, in a situation in which there are many sound sources (e.g., audio sources), the convolution computation may become a bottleneck in processing the binaural rendering. It turns out, however, that the HRTFs depend only on the angle of a sound source with respect to the listener (e.g., point on a unit sphere with the listener at center) and the reverb TFs depend only on the distances of the sound sources from the listener. Accordingly, when the sound sources are arranged along a line at an angle with respect to the listener, the HRTFs are the same for each of those sound sources and the respective convolutions can be reduced to a single convolution with the sum of the sound fields from the sound sources along the line. Moreover, when the sound sources are arranged along a circular arc with the listener at center, the reverb TFs are the same for each of those sound sources and the respective convolutions can be reduced to a single convolution with the sum of the sound fields from the sound sources along the arc. Thus, by finding a set of sound sources that lie along a curve (e.g., line or arc), the number of convolutions to compute in the binaural rendering of the audio field may be reduced, thus significantly reducing the computational burden of binaural rendering.

In one general aspect, a method includes identifying a set of sound sources in a three-dimensional space having positions that, within a threshold, intersect a curve, the curve being defined by a parameter value that is constant along the curve. The method also includes summing sound fields from the set of sound sources to produce a net sound field. The method further includes performing a convolution operation on the net sound field and a transfer function to produce a binaurally rendered sound field, the transfer function depending on the parameter value.

In another general aspect, computer program product comprising a nontransitory storage medium, the computer program product including code that, when executed by at least one processor, causes the at least one processor to perform a method. The method includes identifying a set of sound sources in a three-dimensional space that, within a threshold, intersect a curve, the curve being defined by a parameter value that is constant along the curve. The method also includes summing sound fields from the set of sound sources to produce a net sound field. The method further includes performing a convolution operation on the net sound field and a transfer function to produce a binaurally rendered sound field, the transfer function depending on the parameter value.

In another general aspect, an apparatus includes memory and processing circuitry coupled to the memory. The processing circuitry is configured to identify a set of sound sources in a three-dimensional space that, within a threshold, intersect a curve, the curve being defined by a parameter value that is constant along the curve. The processing circuitry is also configured to sum sound fields from the set of sound sources to produce a net sound field. The processing circuitry is further configured to perform a convolution operation on the net sound field and a transfer function to produce a binaurally rendered sound field, the transfer function depending on the parameter value.

The details of one or more implementations are set forth in the accompanying drawings and the description below. Other features will be apparent from the description and drawings, and from the claims.

### BRIEF DESCRIPTION OF THE DRAWINGS

FIG. 1A is a diagram that illustrates an example audio arrangement with a set of sound sources and a listener.

FIG. 1B is a diagram that illustrates an example computation involved in binaural rendering of the audio from the sound sources in FIG. 1A for the listener.

FIG. 2A is a diagram that illustrates an example audio arrangement with a set of sound sources arranged along an arc and a listener.

FIG. 2B is a diagram that illustrates an example computation involved in binaural rendering of the audio from the sound sources in FIG. 2A for the listener.

FIG. 3A is a diagram that illustrates an example audio arrangement with a set of sound sources arranged along a line and a listener.

FIG. 3B is a diagram that illustrates an example computation involved in binaural rendering of the audio from the sound sources in FIG. 3A for the listener.

FIG. 4 is a flow chart that illustrates an example process of determining sound sources that lie along a curve of constant parameter.

FIG. 5 is a diagram that illustrates an example electronic environment for performing the improved techniques described herein.

FIG. 6 is a flow chart that illustrates an example method of performing the binaural rendering according to the improved techniques described herein.

### DETAILED DESCRIPTION

A sound field generated at an array of virtual sound sources can reproduce the effect of a sound source from any vantage point relative to a listener. Such a sound field may be decoded and used in the delivery of audio through headphone speakers in, e.g., Virtual Reality (VR) and/or augmented reality (AR) systems. Frequently, such rendering takes into account the effect of a human auditory system using a set of Head-Related Transfer Functions (HRTFs). Performing convolutions on signals from each sound source with the set of HRTFs provides the listener with a faithful reproduction of the sound source. In addition, an audio signal may reflect from obstacles and the boundaries of a room; this is represented in a reverb transfer function.

Approaches to performing binaural rendering involve performing four convolutions per sound source signal, i.e., a convolution of a HRTF with a decoded signal for that sound source for each ear (L,R) as well as a convolution of a reverb transfer function for each ear.

It is noted that the HRTFs and the reverb transfer functions (TFs) are examples of transfer functions used in the computation of the sound field at the ears of a listener. Generally speaking, a a transfer function herein is a function in the time domain that, when convolved with an audio field from a sound source, describes a physical effect on the audio field from the sound source. For example, a HRTF that provides binaural rendering of the audio field into the sound field at the ear describes the physical effect of the human head anatomy on the audio field. Also, the reverb TF describes the effect of room reverberation on the audio field.

A technical problem with the above-described conventional approaches is that the number of convolutions of HRTFs and reverb transfer functions is linearly proportional to the number of spatial sound sources that are to be used in a three-dimensional space. In cases with a larger number of sound sources, the linear proportional relationship may cause increased usage of computational resources and computational bottlenecks when there are many sound sources in the three-dimensional space. In addition, there may be increased memory usage, increased requirements for computational capacity, increased power usage, and increased latency due to the number of convolutions that must be computed.

A technical solution to some or all of the above technical problems includes using the fact that the HRTF depends on a sound source position on a unit sphere relative to a listener while the reverb transfer function depends on a range relative to the listener. In this way, sound source positions along a line in three-dimensional space have an identical HRTF while speaker positions along a circular arc in three-dimensional space have an identical reverb transfer function. Accordingly, those sound source positions along a line use a common HRTF in a single convolution for each ear, and those speaker positions along an arc use a common reverb transfer function in a single convolution for each ear. As a result, the number of convolutions that need to be computed will be decreased, thus reducing some or all of the necessary computational capacity, used computation, used memory resources, and power usage. The latency of calculating the transfer functions may also be reduced.

A technical advantage of the above-described technical solution is that it reduces the computational burden of the binaural rendering of the audio fields from the sound sources, especially when there are a large number of such sound sources.

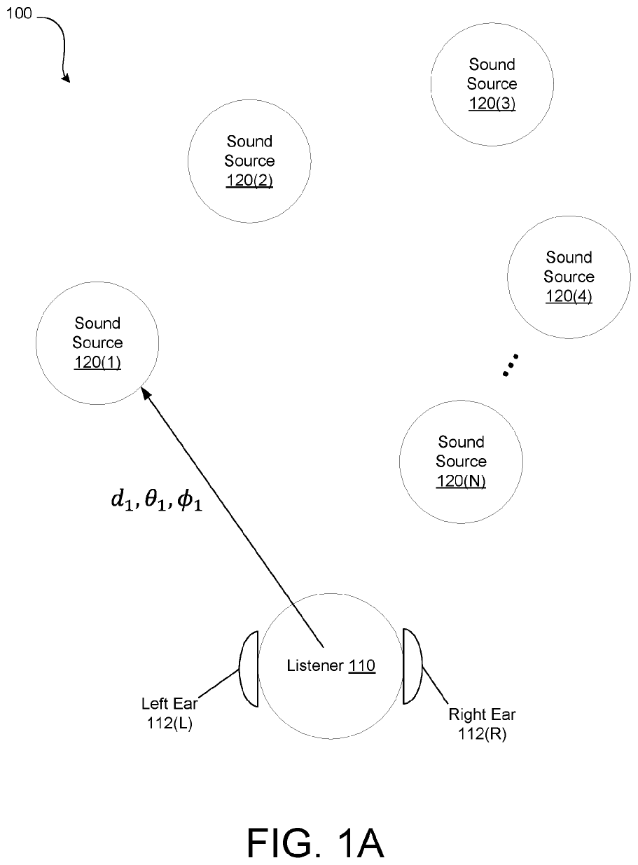

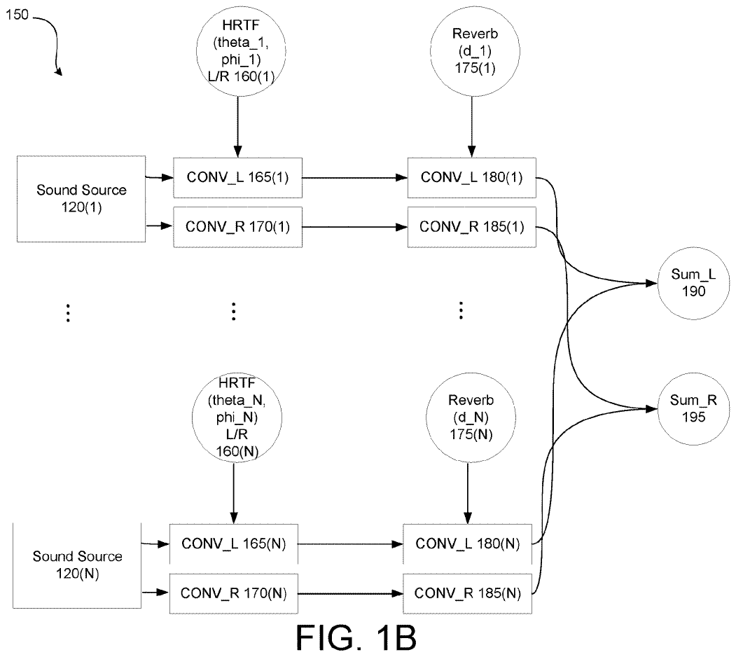

FIG. 1A is a diagram that illustrates an example top-down view of an audio arrangement 100 with a group of sound sources and a listener. As shown in FIG. 1A, there is a listener 110 and a group of sound sources (audio sources) 120(1), 120(2), 120(3), 120(4), . . . , 120(N) of interest arranged in three-dimensional space in a vicinity of the listener. The listener 110 and the sound sources 120(1 . . . N) are arranged in a room with walls (not shown).

The listener 110 is a human with a left ear 112(L) and a right ear 112(R). Herein, the listener is stationary with respect to the sound sources 120(1 . . . N), but this is not a requirement.

Each sound source 120(k), 1≤k≤N, is a source of an audio signal that propagates to the listener 110. Each sound source 120(k) is at a respective distance dk from the center of the head of the listener 110. With respect to the center of the head of the listener 110, each sound source 120(k) is at a polar angle θₖ and azimuthal angle φₖ (e.g., at a point on the surface of a unit sphere (θₖ, φₖ) with the center of the listener's head at center). Each sound source 120(k) may be a speaker, a person, or any audio source.

FIG. 1B is a diagram that illustrates an example computation 150 involved in binaural rendering of the audio from sound sources 120(1 . . . N) in FIG. 1A for the listener 110. The audio field y rendered at the listener's left ear 112(L) from all of the sound sources 120(1 . . . N) is derived as follows. Consider the audio field received at the listener from the kth sound source x^{(k)}. To render this field binaurally, the field is convolved with a left HRTF H^{(L,k)} from the kth sound source to produce an intermediate field, and this intermediate field is convolved with the reverb TF from the kth sound source U^{(k)}. The result is as follows for the temporal signal.

$${y}^{( L )} = {\sum }_{k = 1}^{N} {x}^{( k )} ⊗ {H}^{( L , k )} ⊗ {U}^{( k )} , \qquad ( 1 )$$

where ⊗ denotes convolution. The result for the right ear is similar but using the right HRTF H^{(R,k)}.

$${y}^{( R )} = {\sum }_{k = 1}^{N} {x}^{( k )} ⊗ {H}^{( R , k )} ⊗ {U}^{( k )} . \qquad ( 2 )$$

The computation of the above equations is illustrated in FIG. 1B. The kth sound source is associated with a left and right HRTF 160(k). A computer (e.g., processing circuitry) performs a convolution 165(k) of the signal from the sound source at the listener with the left HRTF from that sound source to produce an intermediate left field. The computer also performs a convolution 170(k) of the signal from the sound source at the listener with the right HRTF from that sound source to produce an intermediate right field. The kth sound source is also associated with a reverb TF 175(k). The computer performs a convolution 180(k) of the intermediate left field with the reverb TF 175(k) to produce a rendered audio field in the left ear and a convolution 185(k) of the intermediate right field with the reverb TF 175(k) to produce a rendered audio field in the right ear. The computer sums the rendered audio field in the left and right ear over the sound sources to produce the left binaurally rendered audio field 190 and the right binaurally rendered audio field 195.

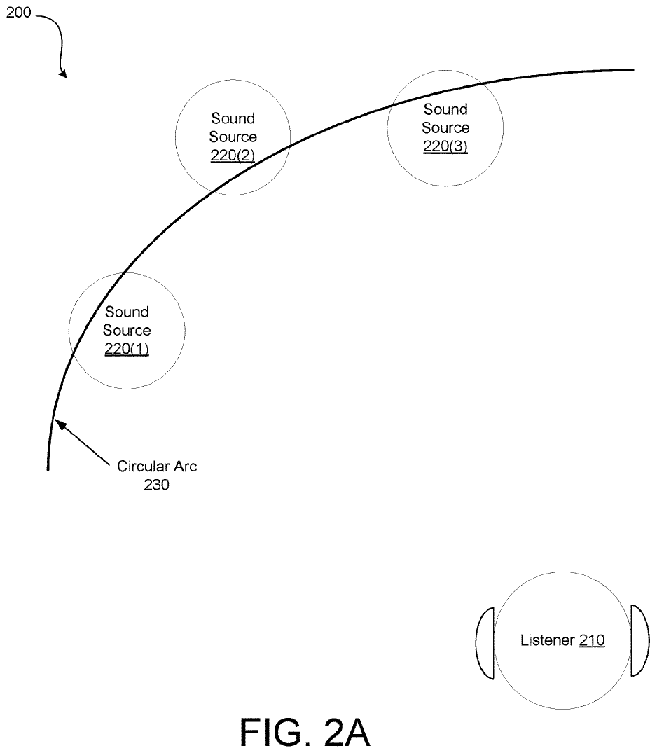

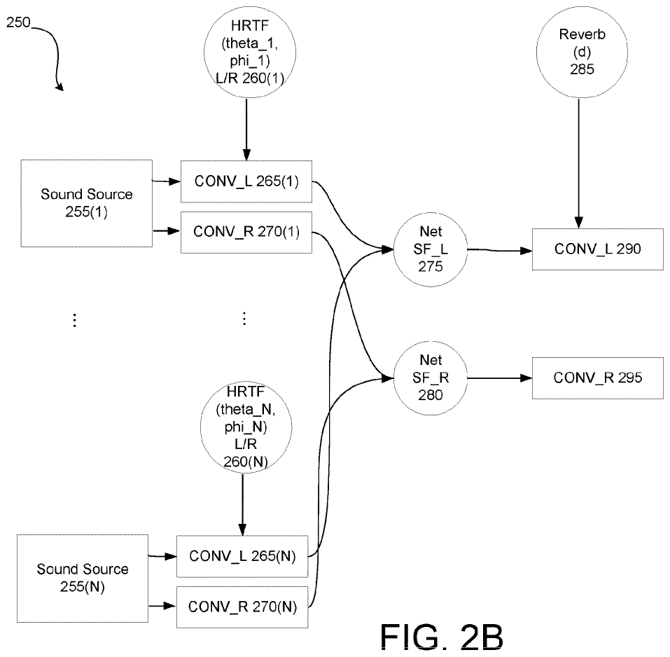

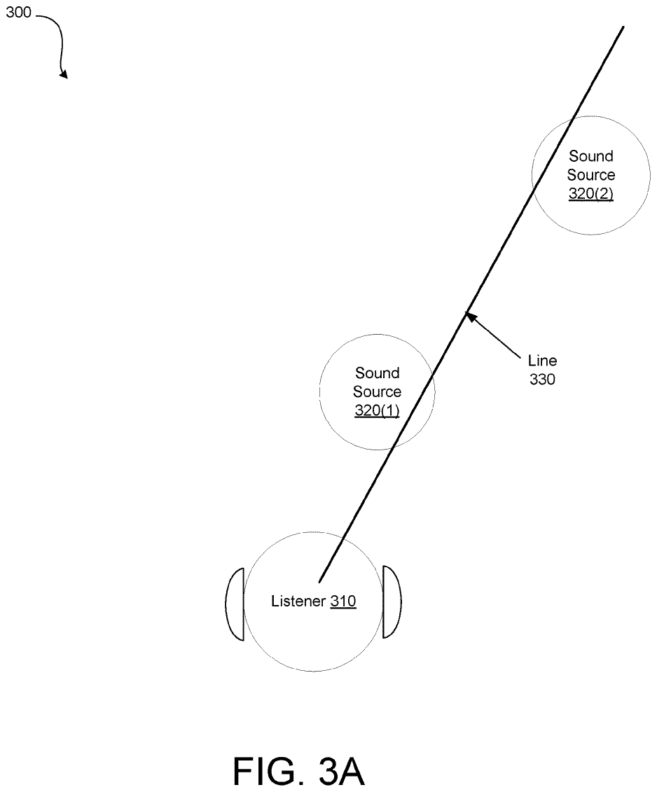

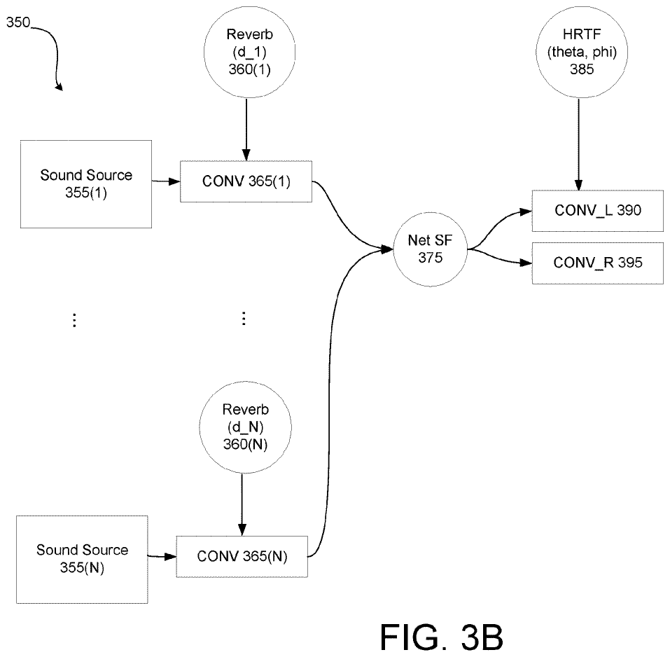

It is noted that Eqs. (1) and (2) represent summations over sound sources of two convolution operations. Accordingly, there are four convolutions for each sound source, and the results are summed. Nevertheless, in some situations the HRTFs and reverb TFs may be the same for certain sound sources. In that case, because of the linearity of the convolution operation, those HRTFs and reverb TFs may be factored, which reduces the number of convolutions to perform. For example, for sound sources that are arranged along a curve having a parameter value that is constant along that curve, either or both of the HRTFs and reverb TFs may be identical along that curve. In some implementations, the curve is a circular arc and the parameter is distance from the listener: because the reverb TF depends on radius, all sound sources arranged on that circular arc may have the same reverb TF. In some implementations, the curve is a line and the parameter is angle; because the HRTF depends on the angle, all sound sources arranged on that line may have the same left and right HRTFs. This phenomenon is illustrated with respect to FIGS. 2A, 2B, 3A, and 3B.

It is also noted that each sound source (sound source) is represented in FIG. 1A as a circle of finite radius. This reflects the fact that a sound source has a position (e.g., the center of the circle) but that the center may lie within a threshold from a curve. Graphically, the curve intersecting any part of the circle is equivalent to the sound source being a threshold from the curve.

It is further noted that a curve having a parameter value constant along the curve is a member of a family of curves that are defined by that parameter value. For example, a circle is a member of a family of curves, each being a curve of constant distance from a listener at its center. A line is a family of curves, each being oriented at a constant angle with respect to the listener.

FIG. 2A is a diagram that illustrates an example audio arrangement 200 with a set of sound sources 220(1), 220(2), and 220(3) arranged along a circular arc 230 and a listener 210 at the center of the circular arc. It is noted that the circular arc 230 does not go through the center of each sound source 220(1), 220(2), 220(3), but rather the sound sources 220(1), 220(2), 220(3) are positioned substantially along the circular arc 230 with their respective centers within a threshold from the circular arc 230. In some implementations, the threshold is about 1 cm, 5 cm, 10 cm, 20 cm, 50 cm, 1 meter, 2 m, 5 m, and so on.

FIG. 2B is a diagram that illustrates an example computation 250 involved in binaural rendering of the audio from sound sources for the listener 210. In this case, however, sound sources 255(1 . . . N) are arranged along a circular arc with the listener at its center. That is, each of the sound sources 255(1 . . . N) are at the same distance from the listener. Accordingly, each of the sound sources 255(1 . . . N) have the same reverb TF U.

Thus, Eqs. (1) and (2) take the following form.

$${y}^{( L )} = ( {\sum }_{k = 1}^{N} {x}^{( k )} ⊗ {H}^{( L , k )} ) ⊗ U , \qquad ( 3 )$$

$${y}^{( R )} = ( {\sum }_{k = 1}^{N} {x}^{( k )} ⊗ {H}^{( R , k )} ) ⊗ U . \qquad ( 4 )$$

That is, the number of convolutions has been reduced from 4N to 2N+2.

FIG. 2B illustrates the computation in Eqs. (3) and (4). For each sound source 255(k), there is a corresponding left and right HRTF 260(k). A computer (e.g., processing circuitry) performs a convolution 265(k) on the left HRTF and a sound field at the listener from that sound source to produce a left intermediate field corresponding to that sound source. The computer also performs a convolution 270(k) on the right HRTF and the sound field at the listener from that sound source to produce a right intermediate field corresponding to that sound source. The computer then sums the left intermediate fields over the sound sources to produce a left net sound field 275 and sums the right intermediate fields over the sound sources to produce a right net sound field 280. The computer then performs a single convolution 290 of the left net sound field 275 and the reverb TF 285 to produce a left binaurally rendered audio field and a single convolution 295 of the right net sound field 280 and the reverb TF 285 to produce a right binaurally rendered audio field.

To summarize, the fact that the reverb TFs of the sound sources are essentially the same when the sound sources lie along a circular arc allows the reverb TF to be factored out of the sums in Eqs. (3) and (4) above. This factoring out of the reverb TF from the sums in Eqs. (3) and (4) significantly reduces the number of convolutions that need to be performed to binaurally render the audio fields in the listener's ears.

FIG. 3A is a diagram that illustrates an example audio arrangement 300 with a set of sound sources 320(1) and 320(2) arranged along a line 330 and a listener 310 at the origin of the line 330. It is noted that the line 330 does not go through the center of each sound source 320(1), 320(2), but rather the sound sources 320(1), 320(2) are positioned substantially along the line 330 with their respective centers within a threshold from the line 330. In some implementations, the threshold is about 1 degree, 2 degrees, 5 degrees, 10 degrees, 20 degrees, and so on.

FIG. 3B is a diagram that illustrates an example computation 350 involved in binaural rendering of the audio from sound sources for the listener 310. In this case, however, sound sources 355(1 . . . N) are arranged along a line with the listener at the origin. That is, each of the sound sources 355(1 . . . N) are along the same angle with respect to the listener. Accordingly, each of the sound sources 355(1 . . . N) have the same HRTFs H^{(L)} and H^{(R)}.

Thus, Eqs. (1) and (2) take the following form.

$${y}^{( L )} = ( {\sum }_{k = 1}^{N} {x}^{( k )} ⊗ {U}^{( k )} ) ⊗ {H}^{( L )} , \qquad ( 5 )$$

$${y}^{( R )} = ( {\sum }_{k = 1}^{N} {x}^{( k )} ⊗ {U}^{( k )} ) ⊗ {H}^{( R )} . \qquad ( 6 )$$

That is, the number of convolutions has been reduced from 4N to N+2.

FIG. 3B illustrates the computation in Eqs. (5) and (6). For each sound source 355(k), there is a corresponding reverb TF 360(k). A computer (e.g., processing circuitry) performs a convolution 365(k) on the reverb TF and a sound field at the listener from that sound source to produce an intermediate field corresponding to that sound source. The computer then sums the intermediate fields over the sound sources to produce a net sound field 375. The computer then performs a single convolution 390 of the net sound field 375 and the left HRTF 385 to produce a left binaurally rendered audio field and a single convolution 395 of the net sound field 375 and the right HRTF 385 to produce a right binaurally rendered audio field.

To summarize, the fact that the HRTFs of the sound sources are essentially the same when the sound sources lie along a line allows the HRTFs to be factored out of the sums in Eqs. (5) and (6) above. This factoring out of the HRTFs from the sums in Eqs. (5) and (6) significantly reduces the number of convolutions that need to be performed to binaurally render the audio fields in the listener's ears.

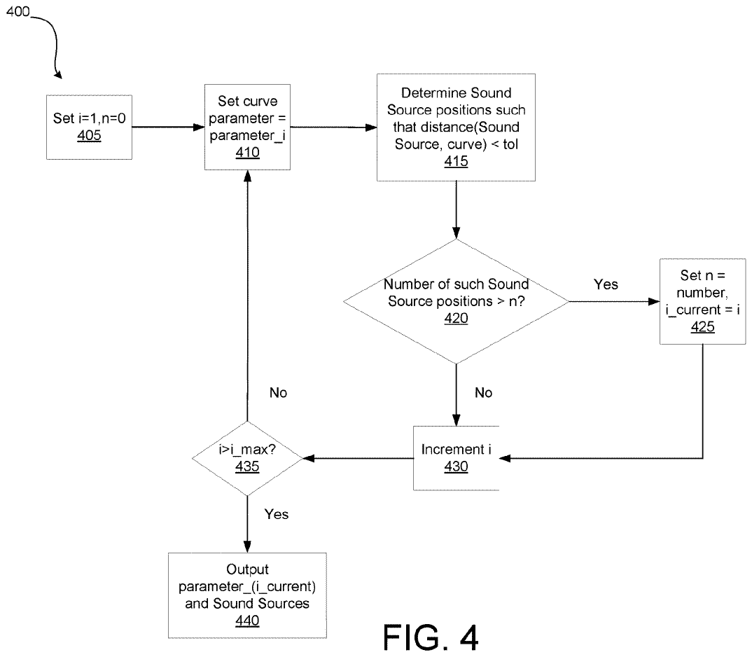

One issue that has not yet been discussed in detail is finding sound sources from a set of sound sources that lie along a curve such as a circular arc or a line. In a situation with a set of sound sources in a room with a listener, it is usually not clear which sound sources may lie along such a curve. An algorithm for finding such sound sources is illustrated with respect to FIG. 4.

FIG. 4 is a flow chart that illustrates an example process 400 of determining sound sources that lie along a curve of constant parameter, such as a circular arc with the listener at the center or a line through the listener. Consider a curve γ(p) where p is a parameter. For example, γ(r) may be a circle of radius r or γ(θ,φ) is a line through a point (θ,φ) on the unit sphere. The problem is to evaluate the following quantity:

$${arg max}_{p} {\sum }_{k = 1}^{N} 𝒥 [ {‖ {S}_{k} - γ ( p ) ‖}_{2}^{2} < ε ] \qquad ( 7 )$$

where [symbol] is an indicator function (e.g., 1 if the condition in the argument is true, 0 if false), Sₖ is the position of the kth sound source in three-dimensional space, and ε is a distance threshold. That is, the goal is to find the curve (e.g., circular arc, line) along which there are as many sound sources within a threshold ε as possible.

The approach described herein is a grid search over the parameter p. That is, the parameter p takes on the values pᵢ, i∈[1, iₘₐₓ]. Nevertheless, other methods can also be used to determine the optimal parameter value, e.g., simulated annealing.

Referring to the flow chart in FIG. 4, at 405, the values used in the grid search are initialized: i=1, n=0. At 410, the value of the parameter is set to pᵢ. For example, if the curve is a circle, then the parameter is the radius, and the grid search may take the form pᵢ=0.5 i, where i varies from 1 to 20.

At 415, the sound sources that satisfy the criterion

$${‖ {S}_{k} - γ ( {p}_{i} ) ‖}_{2}^{2} < ε$$

are determined. This criterion is equivalent to a distance metric between each sound source and the curve being less than a threshold. In some implementations, in which the curve is a circular arc, the threshold is about 1 cm, 5 cm, 10 cm, 20 cm, 50 cm, 1 meter, 1.5 m 2 m, 5 m, and so on, or values in between those thresholds. In some implementations, in which the curve is a line, the threshold is 1 degree, 2 degrees, 5 degrees, 10 degrees, 15 degrees, 20 degrees, and so on, or values in between those thresholds.

At 420, the number of sound sources satisfying the criterion is counted. If the number of sound sources is greater than the current value of n, then at 425 the current value of n is set to the number of sound sources satisfying the criterion and the current value of i is noted. In either case, at 430, the value of i is incremented at 430.

At 435, if the value of i>iₘₐₓ then the parameter value at the current value of i is output and the sound sources along the curve corresponding to that parameter value are identified. If not, then the algorithm returns to step 410. In this way, the curve that includes the maximum number of sound sources may be found.

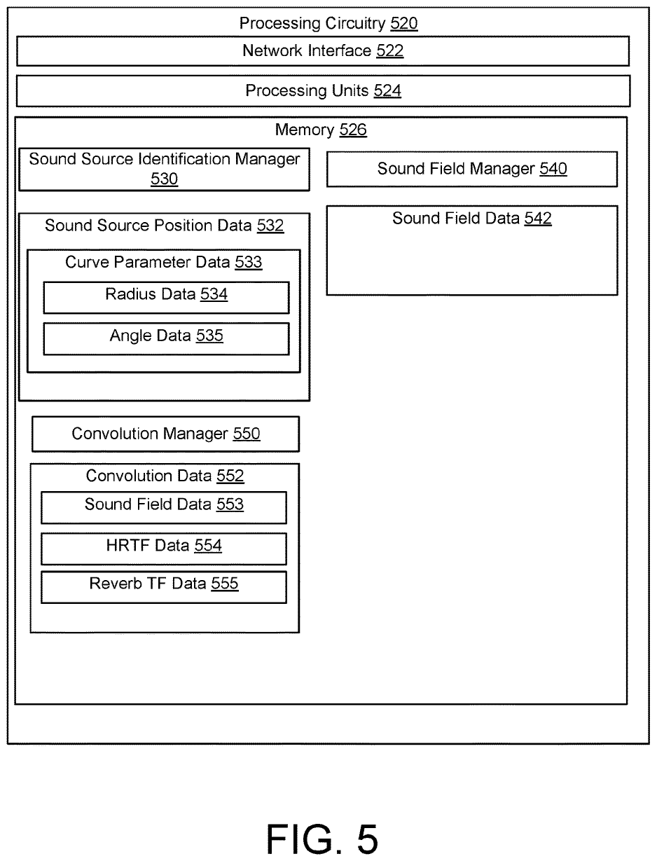

FIG. 5 is a diagram that illustrates an example electronic environment for performing binaural rendering of sound fields. The processing circuitry 520 includes a network interface 522, one or more processing units 524, and nontransitory memory (storage medium) 526.

In some implementations, one or more of the components of the processing circuitry 520 can be, or can include processors (e.g., processing units 524) configured to process instructions stored in the memory 526 as a computer program product. Examples of such instructions as depicted in FIG. 5 include sound source identification manager 530, sound field manager 540, and convolution manager 550. Further, as illustrated in FIG. 5, the memory 526 is configured to store various data, which is described with respect to the respective services and managers that use such data.

The sound source identification manager 530 is configured to identify sound sources that are positioned along a curve by which a transfer function (e.g., a reverb TF, a HRTF) may have a constant value, as for example in the algorithm described with respect to FIG. 4. The sound source identification manager 530 as a consequence is configured to output sound source position data 532, which includes identifiers for sound sources along the curve having the parameter value determined from Eq. (7).

The sound field manager 540 is configured to produce sound field data 542 by summing the sound fields at the listener from the sound sources identified in the sound source position data 532.

The convolution manager 550 is configured to perform the convolutions with the reverb TF and HRTFs for binaural rendering of the sound fields in the listener's ears, according to Eqs. (3) and (4), or (5) and (6). To perform the convolutions, the convolution manager 550 uses convolution data 552, including the sound field data 553, HRTF data 554, and reverb TF data 555.

In some implementations, the sound field data 553 may be derived from the sound field data 542 by propagating the sound field represented by sound field data 542 to each of the listener's ears.

The components (e.g., modules, processing units 524) of processing circuitry 520 can be configured to operate based on one or more platforms (e.g., one or more similar or different platforms) that can include one or more types of hardware, software, firmware, operating systems, runtime libraries, and/or so forth. In some implementations, the components of the processing circuitry 520 can be configured to operate within a cluster of devices (e.g., a server farm). In such an implementation, the functionality and processing of the components of the processing circuitry 520 can be distributed to several devices of the cluster of devices.

The components of the processing circuitry 520 can be, or can include, any type of hardware and/or software configured to process private data from a wearable device in a split-compute architecture. In some implementations, one or more portions of the components shown in the components of the processing circuitry 520 in FIG. 5 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processing circuitry 520 can be, or can include, a software module configured for execution by at least one processor (not shown). In some implementations, the functionality of the components can be included in different modules and/or different components than those shown in FIG. 5, including combining functionality illustrated as two components into a single component.

The network interface 522 includes, for example, wireless adaptors, and the like, for converting electronic and/or optical signals received from the network to electronic form for use by the processing circuitry 520. The set of processing units 524 include one or more processing chips and/or assemblies. The memory 526 includes both volatile memory (e.g., RAM) and non-volatile memory, such as one or more ROMs, disk drives, solid state drives, and the like. The set of processing units 524 and the memory 526 together form processing circuitry, which is configured and arranged to carry out various methods and functions as described herein.

Although not shown, in some implementations, the components of the processing circuitry 520 (or portions thereof) can be configured to operate within, for example, a data center (e.g., a cloud computing environment), a computer system, one or more server/host devices, and/or so forth. In some implementations, the components of the processing circuitry 520 (or portions thereof) can be configured to operate within a network. Thus, the components of the processing circuitry 520 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the processing circuitry 520 can be, or can include, processors configured to process instructions stored in a memory. For example, sound source identification manager 530 (and/or a portion thereof), sound field manager 540 (and/or a portion thereof), and convolution manager 550 (and/or a portion thereof) are examples of such instructions.

In some implementations, the memory 526 can be any type of memory such as a random-access memory, a disk drive memory, flash memory, and/or so forth. In some implementations, the memory 526 can be implemented as more than one memory component (e.g., more than one RAM component or disk drive memory) associated with the components of the processing circuitry 520. In some implementations, the memory 526 can be a database memory. In some implementations, the memory 526 can be, or can include, a non-local memory. For example, the memory 526 can be, or can include, a memory shared by multiple devices (not shown). In some implementations, the memory 526 can be associated with a server device (not shown) within a network and configured to serve the components of the processing circuitry 520. As illustrated in FIG. 5, the memory 526 is configured to store various data, including sound source position data 532, sound field data 542, and convolution data 552.

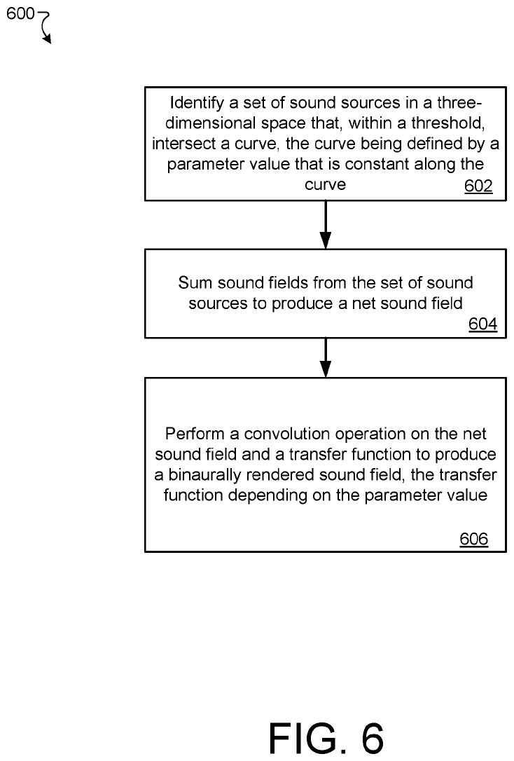

FIG. 6 is a flow chart that illustrates an example method 600 of performing binaural rendering of sound fields. The method 600 may be performed using the processing circuitry 520 of FIG. 5.

At 602, the sound source identification manager 530 identifies a set of sound sources (e.g., sound sources 220(1 . . . 3)) in a three-dimensional space that are positioned substantially along a curve (e.g., circular arc 230) having a parameter value that is constant along the curve.

At 604, the sound field manager 540 sums sound fields from the set of sound sources to produce a net sound field (e.g., net sound field 275).

At 606, the convolution manager 550 performs a convolution operation on the net sound field and a transfer function to produce a binaurally rendered sound field, the transfer function depending on the parameter value so that the transfer function has identical values for the set of sound sources positioned substantially along the curve.

Specific structural and functional details disclosed herein are merely representative for purposes of describing example embodiments. Example embodiments, however, may be embodied in many alternate forms and should not be construed as limited to only the embodiments set forth herein.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 70 degrees or at other orientations) and the spatially relative descriptors used herein may be interpreted accordingly.

Example embodiments of the concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example embodiments.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1-24. (canceled)

25. A method, comprising:
identifying a first sound source configured to produce a first audio signal and a second sound source configured to produce a second audio signal, the first sound source and the second sound source being aligned, within a physical environment, on a curve defined by a parameter;
generating a sound field by combining the first audio signal and the second audio signal; and
rendering the sound field by generating a product of the sound field and a function depending on the parameter.

26. The method as in claim 25, wherein the parameter is distance from a listener and the curve is a circular arc.

27. The method as in claim 25, wherein the parameter has a constant value along the curve.

28. The method as in claim 25, wherein combining the first audio signal and the second audio signal includes:
generating a product of the first audio signal and a head-related transfer function corresponding to the first sound source.

29. The method as in claim 27, wherein identifying the first sound source and the second sound source includes:
for a circular arc of a specified radius, determining a position of a sound source having a distance from the circular arc that is less than a threshold.

30. The method as in claim 29, wherein the circular arc has a number of positions of sound sources having distances from the circular arc that are less than the threshold.

31. The method as in claim 29, wherein the threshold is between 0.5 meters and 1.5 meters.

32. The method as in claim 25, wherein the parameter is position on a unit sphere with a listener at an origin of the unit sphere, and the curve is a line through the origin and the position on the unit sphere.

33. The method as in claim 32, wherein the function is a reverb transfer function; and
wherein summing the first audio signal and the second audio signal includes:
generating a product of the first audio signal and the reverb transfer function corresponding to the first sound source.

34. The method as in claim 32, wherein identifying the first sound source and the second sound source includes:
for a line through a specified point on the unit sphere, determining a position of a sound source having distances from the line that are less than a threshold.

35. The method as in claim 34, wherein the line has a number of positions of sound sources having distances from the line that are less than the threshold.

36. The method as in claim 35, wherein the threshold is between 5 degrees and 15 degrees.

37. A computer program product comprising a nontransitory storage medium, the computer program product including code that, when executed by processing circuitry, causes the processing circuitry to perform a method, the method comprising:
identifying a first sound source configured to produce a first audio signal and a second sound source configured to produce a second audio signal, the first sound source and the second sound source being aligned, within a physical environment, on a curve defined by a parameter;
generating a sound field by combining the first audio signal and the second audio signal; and
rendering the sound field by generating a product of sound field and a function depending on the parameter.

38. The computer program product as in claim 37, wherein the parameter is distance from a listener and the curve is a circular arc.

39. The computer program product as in claim 38, wherein combining the first audio signal and the second audio signal includes:
generating a product of the first audio signal and a head-related transfer function corresponding to the first sound source.

40. The computer program product as in claim 37, wherein identifying the first sound source and the second sound source includes:
for a circular arc of a specified radius, determining a position of a sound source having a distance from the circular arc that is less than a threshold.

41. The computer program product as in claim 40, wherein the circular arc has a number of positions of sound sources having distances from the circular arc that are less than the threshold.

42. The computer program product as in claim 40, wherein the threshold is between 0.5 meters and 1.5 meters.

43. The computer program product as in claim 37, wherein the parameter is position on a unit sphere with a listener at an origin of the unit sphere, and the curve is a line through the origin and the position on the unit sphere.

44. The computer program product as in claim 43, wherein the function is a reverb transfer function; and
wherein summing the first audio signal and the second audio signal includes:
generating a product of the first audio signal and a reverb transfer function corresponding to the first sound source.

45. The computer program product as in claim 43, wherein identifying the first sound source and the second sound source includes:
for a line through a specified point on the unit sphere, determining a position of a sound source having distances from the line that are less than a threshold.

46. The computer program product as in claim 45, wherein the line has a number of positions of sound sources having distances from the line that are less than the threshold.

47. The computer program product as in claim 45, wherein the threshold is between 5 degrees and 15 degrees.

48. An electronic apparatus, comprising:
memory; and
a processor coupled to the memory, the processor being configured to:
identify a first sound source configured to produce a first audio signal and a second sound source configured to produce a second audio signal, the first sound source and the second sound source being arranged on a curve defined by a parameter;
generating a sound field by combining the first audio signal and the second audio signal; and
rendering the sound field by generating a product of the sound field and a function depending on the parameter.

49. The electronic apparatus as in claim 48, wherein the parameter is distance from a listener, the curve is a circular arc, and the function is a reverb transfer function.

50. The electronic apparatus as in claim 49, wherein the processor configured to combine the first audio signal and the second audio signal is further configured to:
generate a product of the first audio signal and the reverb transfer function corresponding to the first sound source.
